(19) United States
(12) Patent Application Publication
(10) Pub. No.: US 2025/0166361 A1
(43) Pub. Date: May 22, 2025

(54) WORK ANALYSIS DEVICE

(71) Applicant: FANUC CORPORATION, Minamitsuru-gun, Yamanashi (JP)

(72) Inventors: Tomofumi UWANO, Yamanashi (JP); Kazuhiro YAMATO, Yamanashi (JP)

(21) Appl. No.: 18/841,809

(22) PCT Filed: Mar. 31, 2022
(86) PCT No.: PCT/JP2022/016971

§ 371 Date: Aug. 27, 2024

(51) Int. Cl. G06V 10/776; G06V 20/40; G06V 20/52; G06V 20/70; G06V 40/20

(52) U.S. Cl. CPC G06V 10/776; G06V 20/41; G06V 20/52; G06V 20/70; G06V 40/20

(57) ABSTRACT

A work analysis device includes a work labelling unit that assigns, to video data including work of a worker, a work label for the worker, an object detection annotation unit that, with respect to the video data, annotates an object related to the work of the worker, an object detection learning unit that generates an object detection model that performs object detection from video data of an annotated object, and an object detection unit that uses the object detection model to detect an object from video data. The device also includes a work assessment parameter calculation unit that assesses work in video data with a work label, and calculates an assessment criterion which minimizes the error as compared to the assigned work label, and a work assessment unit that uses the object detection model and the assessment criterion to assess work of a worker in new video data.

### TECHNICAL FIELD

The present invention pertains to a task analysis device.

### BACKGROUND ART

It is possible to obtain operational data for machine tool or the like in a factory, but it has not been possible to obtain data regarding a task by a worker, Accordingly, task improvement, giving consideration to the introduction of a robot, and realizing a digital twin or the like for a factory requires the visualization of tasks by workers, and thus a technique for automatically recognizing what has been done from a video of a task by a worker is important.

Regarding this point, there is a known technique that performs machine learning using data to be learned that includes input data, which is an image resulting from capturing a task by a worker, as well as label data for the task by the worker who is indicated by the image, generates a trained model for identifying the task from the image, and uses the trained model to identify which task is being performed in an image to be analyzed. For example, refer to Patent Document 1.

In addition, there is a known technique that identifies the position of a worker's hand from image data that has depth and is captured by a depth sensor, identifies the position of a target object from image data that is captured by a digital camera, and identifies details of an operation performed by the worker during the task. For example, refer to Patent Document 2.

### CITATION LIST

### Patent Document

Patent Document 1: Japanese Unexamined Patent Application, Publication No. 2021-67981

Patent Document 2: PCT International Publication No. NO2017/222070

### DISCLOSURE OF THE INVENTION

### Problems to be Solved by the Invention

However, a classification model such as the trained model in Patent Document 1 has problems of being complex and having low interpretability.

In addition, to detect a tool (object) that is being used from within an image for the purpose of task classification as in Patent Document 2, a large number of calculations are necessary in order to scan the entirety of the image.

Furthermore, accurately determining a task that a worker is performing requires adjusting a determination criterion (parameter) for the task determination, as well as manually searching images of various task scenes and making annotations, which takes time and effort. In addition, there is a problem that it is unknown whether the accuracy of a task determination will increase even if a manual search is performed.

Accordingly, functionality for automatically adjusting and deriving a determination criterion (parameter) for causing a task to be accurately determined is desired.

### Means for Solving the Problems

One aspect of a task analysis device according to the present disclosure is a task analysis device that is for analyzing a task by a worker and includes: a task label assigning unit configured to assign, to video data that includes the task by the worker, a task label that indicates the task by the worker; an object detection annotation unit configured to, with respect to the video data to which the task label has been assigned, make an annotation for an object related to the task by the worker; an object detection learning unit configured to generate an object detection model for performing object detection, from video data regarding the object for which the annotation was made by the object detection annotation unit; an object detection unit configured to use the object detection model to detect the object from the video data; a task determination parameter calculation unit configured to perform a task determination on the video data to which the task label has been assigned, and calculate a determination criterion for minimizing an error with respect to the assigned task label; and a task determination unit configured to use the object detection model and the determination criterion to determine a task by the worker in newly inputted video data.

### Effects of the Invention

By virtue of one aspect, it is possible to automatically adjust and derive a determination criterion (parameter) for causing a task to be accurately determined.

### BRIEF DESCRIPTION OF THE DRAWINGS

FIG. 1 is a functional block diagram illustrating an example of a functional configuration of a task analysis system according to a first embodiment;

FIG. 2 is a view that illustrates an example of a task table;

FIG. 3 is a view that illustrates an example of a user interface for assigning a task label;

FIG. 4 is a view that illustrates examples of video data having different states for a rotary tool;

FIG. 5 is a view that illustrates an example of determination results for task determination;

FIG. 6 is a view that illustrates an example of a misdetection;

FIG. 7 is a view that illustrates an example of an image region in video data;

FIG. 8 is a view that illustrates an example of operation by a dynamic body detection unit;

FIG. 9 is a flow chart for giving a description regarding parameter calculation processing by a task analysis device;

FIG. 10 is a flow chart for giving a description regarding analytical processing by the task analysis device;

FIG. 11 is a functional block diagram illustrating an example of a functional configuration of a task analysis system according to a second embodiment;

FIG. 12 is a view that illustrates an example of joint position information in a frame image;

FIG. 13 is a view that illustrated an example of operation by a joint position task estimation model;

FIG. 14 is a flow chart for giving a description regarding parameter calculation processing by a task analysis device; and

FIG. 15 is a flow chart for giving a description regarding analytical processing by the task analysis device.

### PREFERRED MODE FOR CARRYING OUT THE INVENTION

With reference to the drawings, description is given in detail regarding a first embodiment and a second embodiment of a task analysis device.

Here, these embodiments share a configuration for assigning in advance a task label that indicates a task by a worker to video data (moving image) resulting from capturing a task by the worker, annotating the video data to which the task label was assigned with an object (a tool) that relates to the task by the worker, and generating an object detection model that detects an object from video data that is of an object for which an annotation has been made.

However, in the determination of a task by a worker, in the first embodiment, a generated object detection model is used to perform a task determination for a task by a worker in video data to which a task label has been assigned and a determination criterion for minimizing an error with respect to the assigned task label is calculated, whereby the object detection model and the calculated determination criterion are used to determine a task by a worker in newly inputted video data. In contrast to this, the second embodiment differs to the first embodiment in: estimating joint position information that pertains to joints of a worker; generating a joint position task estimation model for estimating a task by the worker on the basis of the estimated joint position information and an assigned task label; calculating, on the basis of a valve pertaining to the accuracy of object detection for a task determination using an object detection model and a task classification probability that is estimated from joint positions in a task determination that uses the joint position task estimation model, a determination criterion such that an error with respect to the task label is minimized; and using the object detection model, the joint position task estimation model, and the determination criterion to determine a task by a worker in newly inputted video data.

Description is first given in detail below regarding the first embodiment, and subsequently description is given mainly for portions in the second embodiment that differ to the first embodiment.

### First Embodiment

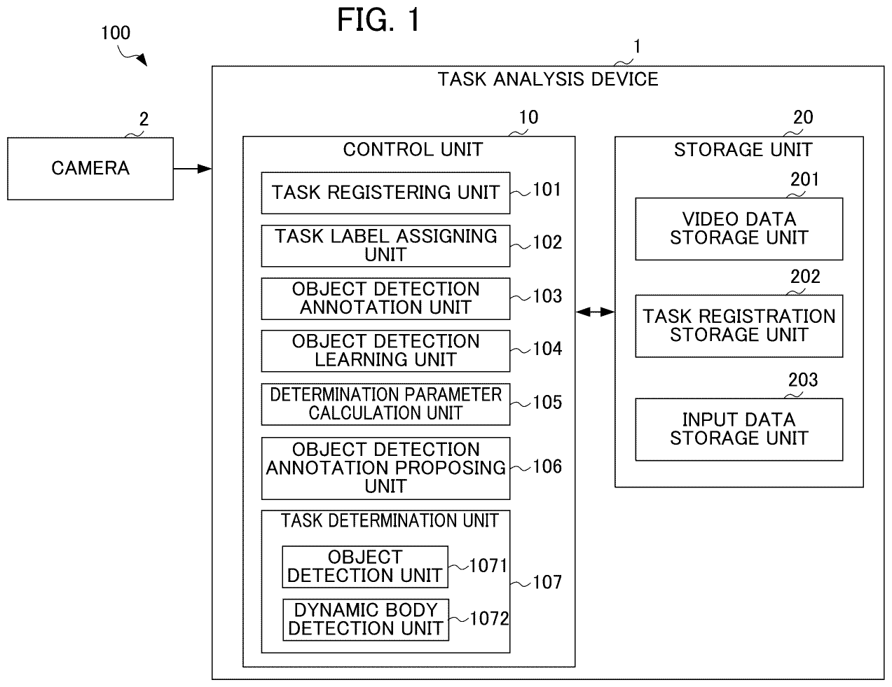

FIG. 1 is a functional block diagram illustrating an example of a functional configuration of a task analysis system according to a first embodiment.

As illustrated in FIG. 1, a task analysis system 100 has a task analysis device 1 and a camera 2.

In addition, the task analysis device 1 and the camera 2 may be connected to each other via a network (not shown) such as a LAN (local area network) or the internet. In this case, it may be that the task analysis device 1 and the camera 2 are each provided with a communication unit (not shown) for communicating with each other via the corresponding connection. Note that the task analysis device 1 and the camera 2 may be directly connected to each other, in a wireless or wired manner, via connection interfaces (not shown).

In addition, the task analysis device 1 is connected to one camera 2 in FIG. 1, but may be connected to two or more cameras 2.

The camera 2 is a digital camera or the like and captures, at a prescribed frame rate (for example, 30 fps, etc.), a two-dimensional frame image resulting from projecting workers and objects such as tools (not shown) onto a plane orthogonal to the optical axis of the camera 2. The camera 2 outputs captured frame images to the task analysis device 1 as video data. Note that video data captured by the camera 2 may be a visible light image such as an RGB color image, a grayscale image, or a depth image.

### Task Analysis Device 1

The task analysis device 1 is a computer device publicly known to a person skilled in the art, and has a control unit 10 and a storage unit 20 as illustrated in FIG. 1. In addition, the control unit 10 has a task registering unit 101, a task label assigning unit 102, an object detection annotation unit 103, an object detection learning unit 104, a task determination parameter calculation unit 105, an object detection annotation proposing unit 106, and a task determination unit 107. In addition, the task determination unit 107 has an object detection unit 1071 and a dynamic body detection unit 1072.

The storage unit 20 is a storage device such as a ROM (Read-Only Memory) or an HDD (Hard Disk Drive). The storage unit 20 stores, inter alia, an operating system and an application program that the control unit 10, which is described below, executes. In addition, the storage unit. 20 includes a video data storage unit 201, a task registration storage unit 202, and an input data storage unit. 203.

The video data storage unit 201 stores video data of workers and objects such as tools that are captured by the camera 2.

The task registration storage unit 202, for example, stores a task table that associates a tool (object) detected by the later-described object detection unit 1071 and a corresponding task by a worker, and is registered in advance by the later-described task registering unit 101 on the basis of an input operation by a user such as a worker via an input device (not shown) such as a keyboard or a touch panel included in the task analysis device 1.

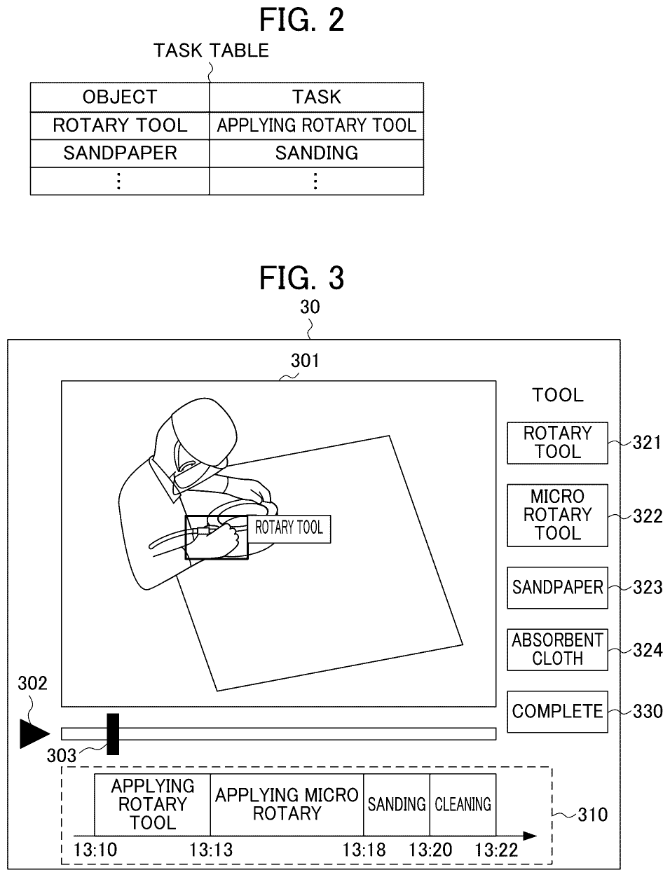

FIG. 2 illustrates an example of a task table.

As illustrated in FIG. 2, the task table has storage regions for “objects” and “tasks”.

The “objects” storage region in the task table stores tool names such as “rotary tool (e.g., Leutor®)” and “sandpaper”, for example.

The “tasks” storage region in the task table stores tasks such as “applying rotary tool” and “sanding”, for example.

For example, the input data storage unit 203 stores, from among frame images in video data, a set of frame image data resulting from associating a tool (object), for which an annotation has been made by the later-described object detection annotation unit 103, with an image range in which the tool appears. The set is to be employed as input data when the later-described object detection learning unit 104 generates an object detection model.

The control unit 10 is something publicly known to a person skilled in the art that has a CPU, a ROM, a RAM (Random-Access Memory), a CMOS memory, etc., with each of these configured to be able to mutually communicate via a bus.

The CPU is a processor that performs overall control of the task analysis device 1. The CPU reads out, via the bus, a system program and an application program that are stored in the ROM, and controls the entirety of the task analysis device 1 in accordance with a system program and the application program. As a result, the control unit 10 is configured to realize functionality for the task registering unit 101, the task label assigning unit 102, the object detection annotation unit 103, the object detection learning unit 104, the task determination parameter calculation unit 105, the object detection annotation proposing unit 106, and the task determination unit 107, as illustrated in FIG. 1. In addition, the task determination unit 107 is configured to realize functionality for the object detection unit 1071 and the dynamic body detection unit 1072. Various data such as temporary calculation data or display data is stored in the RAM. In addition, the CMOS memory is supported by a battery (not shown), and is configured as a non-volatile memory for which a storage state is held even if a power supply for the task analysis device 1 is turned off.

On the basis of an input operation by a user such as a worker made via the input device (not shown) for the task analysis device 1, for example, the task registering unit 101 associates and registers the relationship between a tool (a detected object) used and a task that uses the tool (object) (a task for which there is a desire to recognize), in the task table illustrated in FIG. 2.

The task label assigning unit. 102, for example, when a user looks at video data (moving image data) that includes a task by a worker and is stored in the video data storage unit 201, assigns a task label to the video data (moving image data), a task name to the task being performed by the worker.

FIG. 3 is a view that illustrates an example of a user interface 30 for assigning a task label.

As illustrated in FIG. 3, the user interface 30 has a region 301 for reproducing video data (moving image) stored in the video data storage unit 201, a reproduction stop button 302, a slide 303, a region 310 that indicates task labels that were assigned to video data by the task label assigning unit 102 in time series, a rotary tool button 321 that indicates a tool for which an annotation is made by the later-described object detection annotation unit 103, a micro rotary tool button 322, a sandpaper button 323, an absorbent cloth button 314, and a complete button 330 for completing assignment of a task label and/or annotation of an object.

Specifically, the task label assigning unit 102, for example, displays the user interface 30 on a display device. (not shown) such as an LCD included in the task analysis device 1 and reproduces, in the region 301 in the user interface 30, video data (moving image data) that is stored by the video data storage unit 201. A user operates the reproduction stop button 302 or the slide 303 via the input device (not shown) for the task analysis device 1 to thereby confirm video data. In a case of confirming the task “applying rotary tool” by a worker in the video data during an amount of time from a time 13:10 to a time 13:13, the user inputs the task name “applying rotary tool”, and the task label assigning unit 102 assigns the task label “applying rotary tool” to the video data from the time 13:10 to the time 13:13. In addition, in a case of confirming a task by a worker who is applying a micro rotary tool in the video data during an amount of time from the time 13:13 to a time 13:18, the user inputs the task name “applying micro rotary tool”, and the task label assigning unit 102 assigns the task label “applying micro rotary tool” to the video data from the time 13:13 to the time 13:18. In addition, in a case of confirming a “sanding” task by a worker in the video data during an amount of time from the time 13:18 to a time 13:20, the user inputs the task name “sanding”, and the task label assigning unit 102 assigns the task label “sanding” to the video data from the time 13:18 to the time 13:20. Furthermore, in a case of confirming a “cleaning” task by a worker in the video data during an amount of time from the time 13:20 to a time 13:22, the user inputs the task name “cleaning”, and the task label assigning unit 102 assigns the task label “cleaning” to the video data from the time 13:20 to the time 13:22.

It may be that the task label assigning unit 102 displays results of assigning task labels in the region 310 in time series, on the display device (not shown) belonging to the task analysis device 1. The task label assigning unit 102 outputs video data, to which task labels have been assigned, to the object detection annotation unit 103.

The object detection annotation unit 103, for example, with respect to video data to which task labels have been assigned, makes an annotation for a tool (object) pertaining to task by a worker.

Specifically, for example, the object detection annotation unit 103 displays, in the region 301 in the user interface 30, frame images (still images) in which a tool (object) that is a rotary tool appears, from among video data from the time 13:10 to the time 13:13 to which the task label “applying rotary tool” has been assigned, the frame images (still images) being separated by a prescribed interval or an interval that is arbitrarily defined by a user.

Note that it is desirable for a prescribed interval or an arbitrarily defined interval to be set such that there are approximately 20 frame images (still images) which are displayed for each task label, for example.

As a result, the user can efficiently work without needing to confirm any number of hours of video data, and it is possible to reduce a burden on the user.

On the basis of an input operation by a user, the object detection annotation unit 103 obtains an image range (thick-line rectangle) for a tool (object) that appears for each frame image (still image) as illustrated in FIG. 3, and annotates that the tool (object) is a rotary tool due to the rotary tool button 321 or the like having been pressed. Note that, for each item of video data in which the task label “applying micro rotary tool”, “sanding”, or “cleaning” has been assigned, with respect to a frame image (still image) in which a tool (object) appears, the object detection annotation unit 103 obtains an image range for the tool (object) that appears and makes an annotation for the tool (object), similarly to the case of “applying rotary tool”.

In a case where an image range in which a tool (object) appears and tool (object) annotations are complete for all frame images (still images) in video data to which task labels have been assigned, and the complete button 330 is pressed by a user, the object detection annotation unit 103 stores, in the input data storage unit 203, a set of frame image data (hereinafter, may be referred to as “annotated frame image data”) resulting from associating image ranges for frame images (still images), which are from among video data (moving image data) for an amount of time in which various tasks have been performed (the amount of time from when a task starts until the task ends) and in which a tool appears (having an assigned time stamp), with tools (objects) for which annotations have been made.

The object detection learning unit 104 generates an object detection model for performing object detection from video data regarding an object for which an annotation has been made.

Specifically, the object detection learning unit 104, for example, generates an object detection model that is a trained model such as a neural network that employs annotated frame image data stored in the input data storage unit 203 as input data, and performs publicly known machine learning using teaching data in which a tool (object) for which an annotation has been made is employed as label data. The object detection learning unit 104 stores the generated object detection model in the storage unit 20.

The task determination parameter calculation unit 105 uses the object detection model generated by the object detection learning unit 104 to perform a task determination on video data to which a task label has been assigned, and calculates a determination criterion for minimizing an error with respect to the assigned task label.

Specifically, the task determination parameter calculation unit 105, for example, sets an initial value for a parameter, which serves as a determination criterion, for each task that is registered in the task table in FIG. 2, Note that the parameter includes, inter alia, a number of seconds X for assuming that a task is being performed for X seconds after an object is detected, a threshold for a value pertaining to the accuracy of object detection for determining that the task “applying rotary tool” is being performed, and a threshold for a value pertaining to the accuracy of object detection for determining that the task “sanding” is being performed, for example. The number of seconds X for assuming that a task is being performed for X seconds after object detection is included in a parameter, whereby the task analysis device 1 can make a determination that a task using a tool (object) is being performed if the tool is detected in the most recent X seconds—even in a case where it is not possible to detect the tool (object) using video data, for example.

The task determination parameter calculation unit 105 inputs, to the object detection model, annotated frame image data from among separate video data, which is stored in the input data storage unit 203 and to which a task label has been assigned, and detects a tool (object). The task determination parameter calculation unit 105 determines the task on the basis of an object detection result and the task table in FIG. 2, and calculates an error between the determined task and the correct task label. On the basis of error calculated for all annotated frame image data, the task determination parameter calculation unit 105 calculates an evaluation index such as an F1 score for the parameter value for each task, and uses Bayesian optimization or the like to calculate the parameter value for each task such that the calculated evaluation indexes for each task are maximized.

The object detection annotation proposing unit 106 uses the parameter (determination criterion) calculated by the task determination parameter calculation unit 105 to perform a task determination on video data to which a task label has been assigned and, on the basis of a determination result for the task determination, proposes a frame image (still image) that is to be annotated.

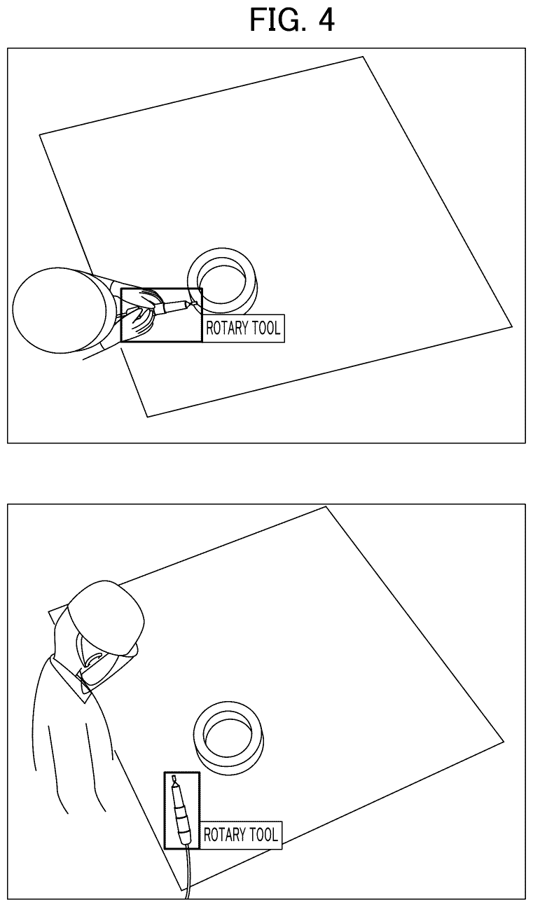

For example, in a case where, in object detection for a rotary tool, training is performed only with video data regarding a state where a worker is holding the rotary tool in their hand as illustrated in the upper portion of FIG. 4, there will be a drop in the value pertaining to the accuracy of object detection for a rotary tool that has been placed on a workbench or the like as illustrated in the lower portion of FIG. 4. Accordingly, video data that has been annotated in a wide range of various scenes is necessary, but it would take time and effort for a user to search through such varied scenes. Therefore, the object detection annotation proposing unit 106 proposes a frame image (still image) that should be automatically annotated, as described below.

Specifically, the object detection annotation proposing unit 106 makes a task determination using image data resulting from associating a tool (object) for which an annotation was made with an image range in which the tool appears, in separate video data which is stored in the input data storage unit 203 and to which a task label has been assigned, for example.

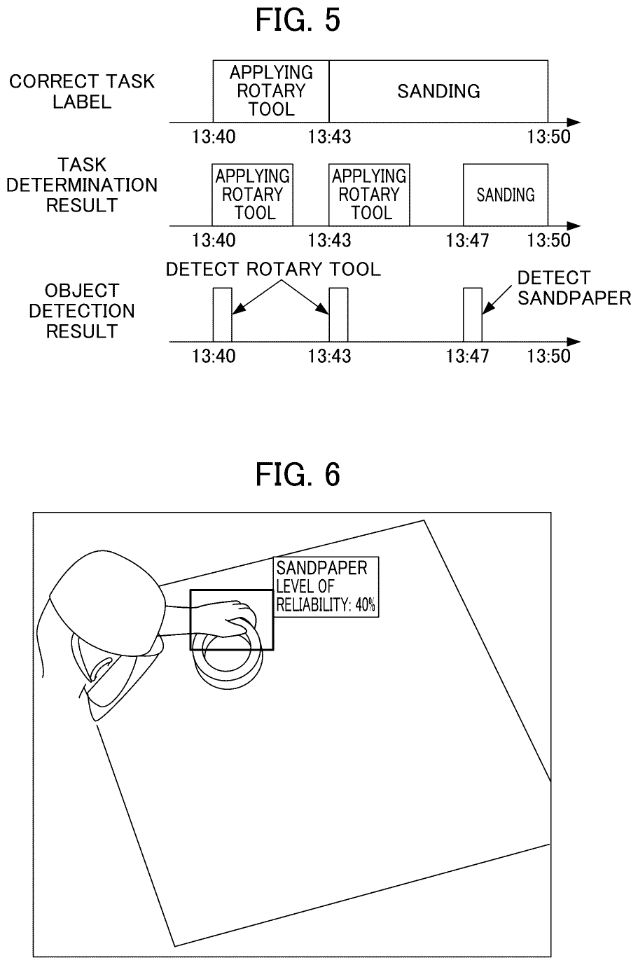

FIG. 5 is a view that illustrates an example of a determination result for a task determination. The upper portion in FIG. 5 illustrates, in time series, correct task labels that have been assigned to the separate video data. The middle portion in FIG. 5 illustrates determination results that are for tasks by a worker and have been made by the object detection annotation proposing unit 106 with respect to the image data and using the object detection model and the parameters. The lower portion in FIG. 5 illustrates object detection results in the image data due to the object detection model.

As illustrated in FIG. 5, in the amount of time that is from the time 13:40 to the time 13:43 and has the correct task label “applying rotary tool”, there is an amount of time in which “applying rotary tool” was not determined (detected) in a task determination result. This is caused by, for example, irrespective of there being frame images (still images) in which a rotary tool appears, the rotary tool was not extracted during the number of seconds X for assuming that a task is being performed for X seconds after the object corresponding to the parameter is detected. Accordingly, in order to increase the value pertaining to the accuracy of object detection, the object detection annotation proposing unit 106 extracts a frame image (still image) in which the rotary tool appears in the separate video data for the amount of time during which “applying rotary tool” was not determined (detected) in the task determination result. Similarly to the object detection annotation unit 103, the object detection annotation proposing unit 106 displays the extracted frame image (still image) in the user interface 30, obtains an image range for a rotary tool in the extracted frame image (still image) on the basis of an input operation by a user, and makes an annotation for a rotary tool due to the rotary tool button 321 being pressed. The object detection annotation proposing unit 106 stores, in the input data storage unit 203, image data that associates an image range for a frame image (still image) in which a rotary tool appears (to which a time stamp has been assigned) with the rotary tool for which the annotation was made.

In addition, as illustrated in FIG. 5, in the amount of time from the time 13:43 to the time 13:50 having the correct task label “sanding”, the task determination result has an amount of time in which “applying rotary tool” has been misdetermined (misdetected), and an amount of time in which “sanding” has not been determined (detected). This misdetermination (misdetection) of “applying rotary tool” is caused by misdetecting a rotary tool in object detection with respect to the frame image (still image) at the time 13:43. In addition, “sanding” not being determined (detected) is caused by, irrespective of there being frame images (still images) in which sandpaper appears, the sandpaper not being extracted in the number of seconds X for assuming that a task is being performed for X seconds after the object in a parameter is detected.

Accordingly, in order to increase the value pertaining to the accuracy of object detection, the object detection annotation proposing unit 106 extracts, from the separate video data, a frame image (still image) in which sandpaper appears near the time 13:43 as well as a frame image (still image) in which sandpaper appears during an amount of time for which “sanding” was not determined (detected). The object detection annotation proposing unit 106 displays each extracted frame image (still image) in the user interface 30, obtains an image range for sandpaper in each frame image (still image) on the basis of input operations by a user, and annotates the tool (object) as sandpaper due to the sandpaper button 323 being pressed. The object detection annotation proposing unit 106 stores, in the input data storage unit 203, image data that associates an image range for a frame image (still image) in which sandpaper appears (to which a time stamp has been assigned) with sandpaper for which an annotation was made.

As a result, it is possible to improve the accuracy of object detection without imposing time and effort for a user to search through various scenes.

Note that, even in a case where the reliability of object detection for a tool (object), which is a value that pertains to the accuracy of object detection, is low and equal to or less than a prescribed value (for example, 20% or the like), it may be that the object detection annotation proposing unit 106 extracts a frame image (still image) in which the tool (object) appears. It may be that the object detection annotation proposing unit 106 displays an extracted frame image (still image) in the user interface 30, obtains an image range for a tool (object) in the extracted frame image (still image) on the basis of an input operation by a user, and makes an annotation for the tool (object).

Subsequently, the object detection learning unit 104 performs machine learning using image data, which includes a frame image (still image) that was annotated with the tool (object) extracted (proposed) by the object detection annotation proposing unit 106, and updates the object detection model. The task determination parameter calculation unit 105 inputs, to the updated object detection model, annotated frame image data that includes a frame image (still image) extracted (proposed) by the object detection annotation proposing unit 106 to thereby determine a task, and calculates the error between an assigned correct task label and a task determination result. On the basis of the calculated error, the task determination parameter calculation unit 105 calculates, for each task, an evaluation index such as an F1 score for a parameter value, and uses Bayesian optimization or the like to recalculate a parameter value for each task such that the calculated evaluation indexes for each task are maximized. For example, the object detection learning unit 104 and the task determination parameter calculation unit 105 repeat processing until there are zero or less than a prescribed number of frame images (still images) that are extracted (proposed) by the object detection annotation proposing unit 106. The object detection learning unit 104 outputs the generated object detection model to the later-described object detection unit 1071, and the task determination parameter calculation unit 105 outputs the calculated parameters to the later-described task determination unit 107.

The task determination unit 107 uses the object detection model and the set parameters (determination criterions) to determine tasks by a worker in video data that is newly inputted from the camera 2.

Specifically, the task determination unit 107, for example, inputs a frame image (still image) belonging to video data that is newly inputted from the camera 2 to an object detection model in the later-described object detection unit 1071, and the later-described dynamic body detection unit 1072. The task determination unit 107 determines a task by a worker on the basis of a tool (object) detection result that is outputted from the object detection model, a detection result from the dynamic body detection unit 1072, the task table in FIG. 2, and the parameters. Note that, in a case where it is not possible to detect a tool (object) using a frame image (still image) from video data, it may be that the task determination unit 107 determines a task by the worker in the frame image on the basis of the parameter regarding the number of seconds X for assuming that the task is performed for X seconds after object detection, in a case where the tool (object) is detected most recently within X seconds from the frame image.

In addition, it may be that, for example, the task determination unit 107 determines “no task” for the determination of a task by a worker in a case where a value pertaining to the accuracy of object detection, such as an object detection level of reliability that is outputted from the object detection model belonging to the object detection unit 1071 or a classification probability for a class, is equal to or less than a preset threshold (for example, 700 or the like). For example, in a case where a worker is simply touching a workpiece in video data as illustrated in FIG. 6, the task determination unit 107 may, in a case of having received an object detection result of “sandpaper” and “level of reliability: 40%”, determine that a task by the worker is “no task” because the level of reliability is below a threshold (for example, 70% or the like).

As a result, it is possible to reduce task misdetection.

The object detection unit 1071 has an object detection model that is generated by the object detection learning unit 104, inputs a frame image (still image) from video data that is newly inputted from the camera 2 to the object detection model, and outputs a tool (object) detection result and a value pertaining to the accuracy of object detection, such as a level of reliability.

The dynamic body detection unit 1072 detects a dynamic body such as a worker or a tool on the basis of change such as change in luminance by a pixel in a designated image region from among each frame image (still image) in video data that is newly inputted from the camera 2.

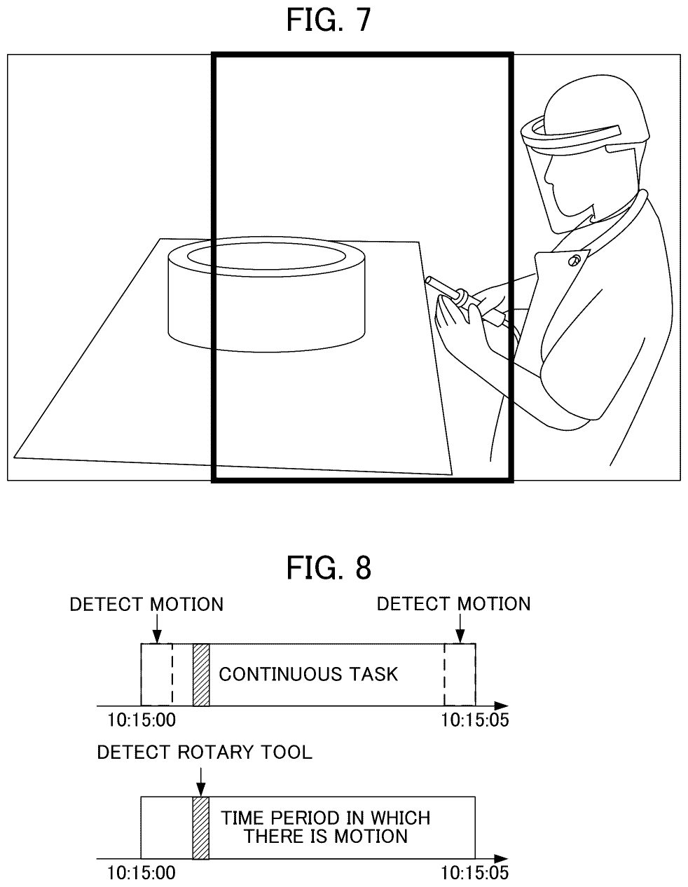

Specifically, it may be that the dynamic body detection unit 1072 determines that a worker in video data is performing a task if there is motion such as a change in luminance by a pixel in an image region that is indicated by a thick line rectangle in a frame image (still image), as illustrated in FIG. 7.

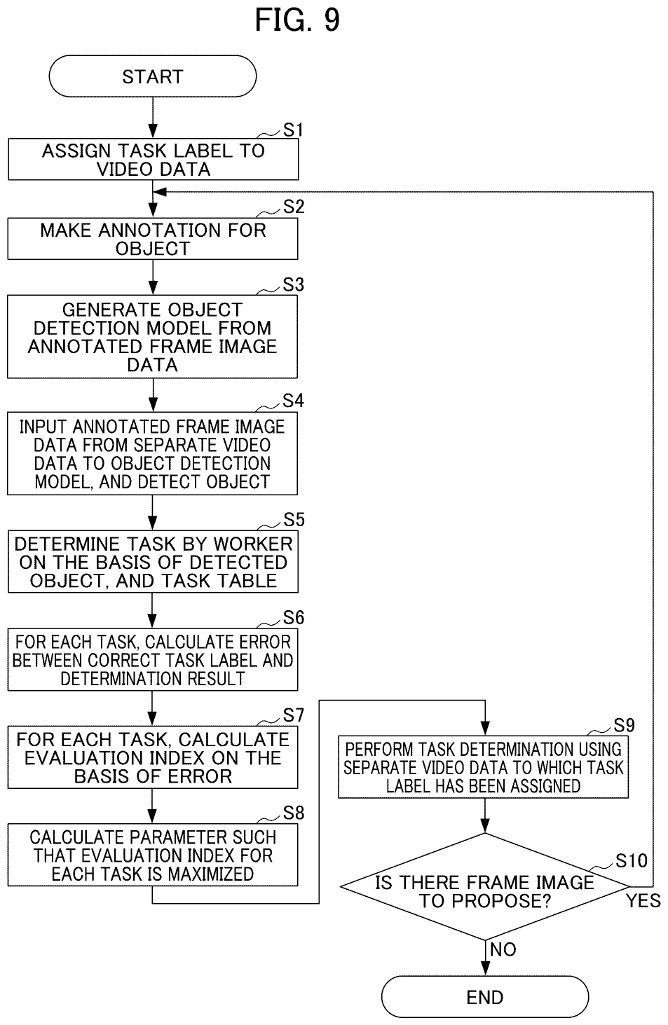

In addition, the dynamic body detection unit 1072 may determine that a worker is continuously performing a task in a case where motion is periodically detected at an interval that is X seconds (for example, 5 seconds or the like) or less and is indicated by a broken-line rectangle, as illustrated in FIG. 8. It may be that, in a case where a tool (object) such as a rotary tool is detected from a frame image (still image) for a point in time indicated by shading by the object detection unit 1071 from among a time period in which motion by a dynamic body is detected, as illustrated in the lower portion of FIG. 8, the dynamic body detection unit 1072 determines that a task using the detected tool (object) is being performed in the time period.

In contrast, it may be that the dynamic body detection unit 1072 does not determine that a worker is performing a task if motion is not detected over in excess of X seconds.

### Parameter Calculation Processing by Task Analysis Device 1

Next, description is given regarding operation pertaining to parameter calculation processing by the task analysis device 1 according to the first embodiment.

FIG. 9 is a flow chart for giving a description regarding parameter calculation processing by the task analysis device 1. The flow illustrated here is executed in a case such as where a new tool (object) and task are registered to the task table by a user such as a worker.

In Step S1, the task label assigning unit 102 reproduces, in the user interface 30, video data that includes a task by a worker and is stored in the video data storage unit 201, and assigns a task label that indicates the task that the worker is performing to the video data on the basis of an input operation by the user.

In Step S2, with respect to frame images (still images) separated by a prescribed interval or the like for each task label from among the video data to which the task label was assigned in Step S1, the object detection annotation unit 103 obtains an image range for a tool (object) that appears and makes an annotation for the tool (object). The object detection annotation unit 103 stores, in the input data storage unit 203, an annotated frame image data that associates a tool (object) for which an annotation was made with an image range in a frame image (still image) in which the tool appears (to which a time stamp has been assigned), from among video data (moving image data) for the amount of time in which each task was performed (amount of time from the start of the task until the end of the task).

In Step S3, the object detection learning unit 104 generates an object detection model for detecting an object from the annotated frame image data, which was annotated in Step S2.

In Step S4, the task determination parameter calculation unit 105 inputs, to the object detection model, annotated frame image data from among separate video data, which is stored in the input data storage unit 203 and to which a task label has been assigned, and detects a tool (object).

In Step S5, the task determination parameter calculation unit 105 determines a task by the worker on the basis of the task table and a result of detecting an object in Step S4.

In Step S6, the task determination parameter calculation unit 105 calculates, for each task, an error between a correct task label and a result of the determination in Step S5.

In Step S7, for each task, an evaluation index such as an F1 score for a parameter value is calculated on the basis of errors that are calculated using all video data.

In Step S8, the task determination parameter calculation unit 105 uses Bayesian optimization or the like to calculate a parameter for each task such that the evaluation index for each task is maximized.

In Step S9, the object detection annotation proposing unit 106 uses the parameters (determination criterions) calculated in Step S8 to perform task determinations for separate video data to which a task label has been assigned.

In Step S10, the object detection annotation proposing unit 106 determines, on the basis of a result of the determination in Step 59, whether there is a frame image (still image) to propose in order to increase a value pertaining to the accuracy of object detection, such as misdetections or undetections, for a location where the value pertaining to the accuracy of object detection is low. In a case where there is a frame image (still image) to propose, the processing returns to Step S2, and the processing in Step S2 through Step S9 is performed again after including the proposed frame image (still image). In contrast, in a case where there is no frame image (still image) to propose, the task analysis device 1 sets the object detection model generated in Step S3 to the object detection unit 1071, sets the parameters that were calculated in Step 88 to the task determination unit 107, and ends the parameter calculation processing.

### Analytical Processing by Task Analysis Device 1

Next, description is given regarding operation pertaining to analytical processing by the task analysis device 1 according to the first embodiment.

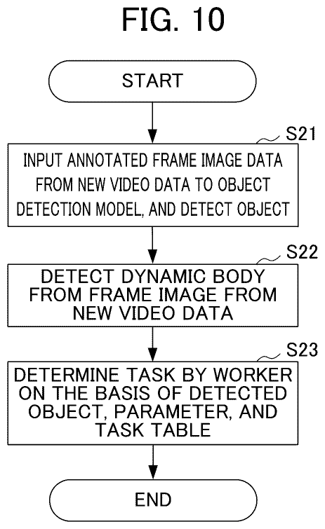

FIG. 10 is a flow chart for giving a description regarding analytical processing by the task analysis device 1. The flow illustrated here is repeatedly executed while video data from the camera 2 is inputted.

In Step S21, the object detection unit 1071 inputs a frame image (still image), which is from video data that was newly inputted from the camera 2, to the object detection model, and detects a tool (object).

In Step S22, the dynamic body detection unit 1072 detects a dynamic body such as a worker or a tool on the basis of change such as change in luminance by a pixel in a designated image region from among each frame image (still image) in video data that is newly inputted from the camera 2.

In Step S23, the task determination unit 107 determines a task by the worker on the basis of the result of detecting a tool (object) in Step 21, the result of detecting a dynamic body in Step S22, the set parameters, and the task table.

As above, the task analysis device 1 according to the first embodiment can automatically adjust a determination criterion for causing a task to be accurately determined. In other words, if a user can label a task and make an annotation for an object, an optimal parameter is automatically calculated.

In addition, in a case where task determination accuracy is insufficient, the task analysis device 1 can automatically propose a frame in a moving image that enables the task determination accuracy to be increased if an annotation is made.

Description was given above regarding the first embodiment.

### Second Embodiment

Next, description is given regarding a second embodiment. In the first embodiment, a generated object detection model is used to perform a task determination for a task by a worker in video data to which a task label has been assigned and a determination criterion for minimizing an error with respect to the assigned task label is calculated, whereby the object detection model and the calculated determination criterion are used to determine a task by a worker in newly inputted video data. In contrast to this, the second embodiment differs to the first embodiment in: estimating joint position information that pertains to joints of a worker; generating a joint position task estimation model for estimating a task by the worker on the basis of the estimated joint position information and an assigned task label; calculating, on the basis of a value pertaining to the accuracy of object detection for a task determination using an object detection model and a task classification probability that is estimated from joint positions in a task determination that uses the joint position task estimation model, a determination criterion such that an error with respect to the task label is minimized; and using the object detection model, the joint position task estimation model, and the determination criterion to determine a task by a worker in newly inputted video data.

As a result, a task analysis device 1A according to the second embodiment can automatically adjust a determination criterion for causing a task to be accurately determined.

Description is given below regarding the second embodiment.

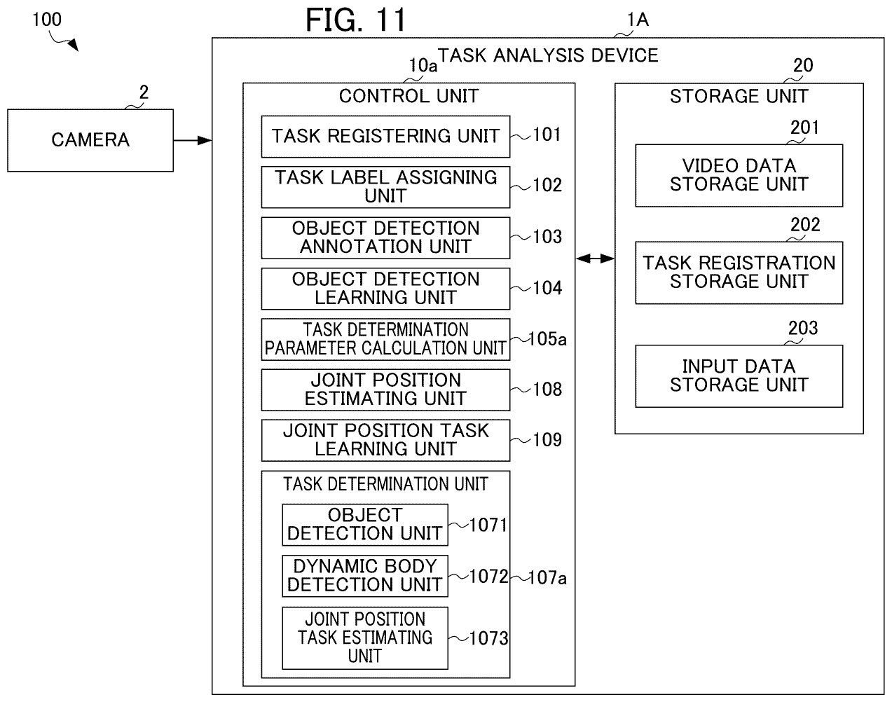

FIG. 11 is a functional block diagram illustrating an example of a functional configuration of a task analysis system according to a second embodiment. Note that the same reference symbols are added to elements having similar functionality to elements in the task analysis system 100 in FIG. 1, and detailed description thereof is omitted.

As illustrated in FIG. 11, a task analysis system 100 has a task analysis device 1A and a camera 2.

The camera 2 has equivalent functionality to the camera 2 in the first embodiment.

### Task Analysis Device 1A

As illustrated in FIG. 11, the task analysis device 1A includes a control unit 10a and a storage unit 20. In addition, the control unit 10a has a task registering unit 101, a task label assigning unit 102, an object detection annotation unit 103, an object detection learning unit 104, a task determination parameter calculation unit 105a, a joint position estimating unit 108, a joint position task learning unit 109, and a task determination unit 107a. In addition, the task determination unit 107a has an object detection unit 1071, a dynamic body detection unit 1072, and a joint position task estimating unit 1073. In addition, the storage unit 20 includes a video data storage unit 201, a task registration storage unit 202, and an input data storage unit. 203.

The storage unit 20, the video data storage unit 201, the task registration storage unit 202, and the input data storage unit 203 have equivalent functionality to the storage unit 20, the video data storage unit 201, the task registration storage unit 202, and the input data storage unit 203 in the first embodiment.

In addition, the task registering unit 101, the task label assigning unit 102, the object detection annotation unit 103, and the object detection learning unit 104 have equivalent functionality to the task registering unit 101, the task label assigning unit 102, the object detection annotation unit 103, and the object detection learning unit 104 in the first embodiment.

In addition, the object detection unit 1071 and the dynamic body detection unit 1072 have equivalent functionality to the object detection unit 1071 and the dynamic body detection unit 1072 in the first embodiment.

The joint position estimating unit 108 estimates joint position information that pertains to joint positions for a worker, for each frame image (still image) in video data, which is stored in the input data storage unit 203 and to which a task label has been assigned. Note that the frame images may be extracted from the video data at an appropriate interval. For example, in a case where the video data has a frame rate of 60 fps, it may be that frame images are extracted at approximately 24 fps, for example.

Specifically, for each frame image (still image) in video data which is stored in the input data storage unit 203 and to which a task label has been assigned, the joint position estimating unit 108 uses a publicly known technique (for example, SUGANO, Kousuke, OKU, Kenta, KAWAGOE, Kyoji, “Motion detection and classification method from multidimensional time series data”, DEIM Forum 2016 G4-5, or UEZONO, Shouhei, ONO, Satoshi, “Feature extraction using LSTM Autoencoder for multimodal sequential data”, JSAI Technical Report, SIG-KBS-B802-1, 2018) to estimate, as joint position information, time series data that has, inter alia, coordinates and an angle for a joint in a worker's hand, arm, or the like.

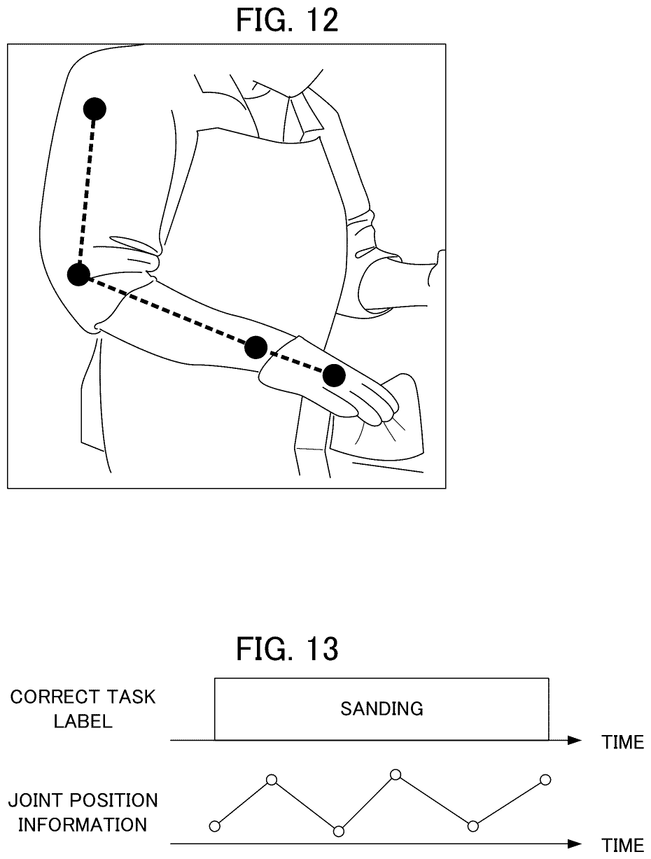

FIG. 12 is a view that illustrates an example of joint position information in a frame image. FIG. 12 illustrates joint position information for when a worker is sanding.

The joint position task learning unit 109, for example, performs machine learning that employs joint position information estimated by the joint position estimating unit 108 as input data and employs the task label assigned by the task label assigning unit 102 as label data, and generates a joint position task estimation model for estimating a task by a worker.

For example, when there is an operation by which joint position information for the right hand belonging to the worker in FIG. 12 makes one round trip in 0.3 seconds or the like as illustrated in FIG. 13, the joint position task learning unit 109 generates a joint position task estimation model such that a determination that sanding is being performed is made.

Note that it may be that the joint position task learning unit 109 generates a rules base on the basis of the joint position information estimated by the joint position estimating unit 108 and the task label assigned by the task label assigning unit 102.

On the basis of a value pertaining to the accuracy of object detection for task determination using an object detection model and a task classification probability that is estimated from joint positions in task determination using the joint position task estimation model, the task determination parameter calculation unit 105a calculates a determination criterion (parameter) such that an error with respect to the task label is minimized.

Specifically, the task determination parameter calculation unit 105a, for example, sets an initial value for each parameter, which corresponds to a determination criterion, for each task that is registered in the task table in FIG. 2, similarly to the task determination parameter calculation unit 105 in the first embodiment. The task determination parameter calculation unit 105a inputs, to the object detection model, annotated frame image data from among separate video data, which is stored in the input data storage unit 203 and to which a task label has been assigned, detects a tool (object), and obtains a value pertaining to object detection. The task determination parameter calculation unit 105a determines a task by the worker on the basis of the task table in FIG. 2 and a result of detecting an object. In addition, the task determination parameter calculation unit 105a estimates joint position information for a worker for each frame image (still image) in the same separate video data and inputs the estimated joint position information to the joint position task estimation model to thereby estimate a task by the worker and obtain an estimated classification probability from the joint positions.

The task determination parameter calculation unit 105a sets a weighting coefficient for the task classification probability estimated from the joint positions to a, sets a weighting coefficient for a value pertaining to the accuracy of object detection to b, and uses the following formula (1) to calculate a value for the parameters (determination criterions), using Bayesian optimization or the like, such that the error between the calculated task classification probability and a correct task label is minimized.

Task classification probability=a (task classification probability estimated from joint positions)+b (value pertaining to the accuracy of object detection) (1)

Here, for example, the parameters include the number of seconds X for assuming that a task is performed for X seconds from object detection, the weight a for the task classification probability estimated from the joint positions, and the weight b for the value pertaining to the accuracy of object detection.

The task determination parameter calculation unit 105a outputs and sets the calculated parameters to the later-described task determination unit 107a.

The task determination unit 107a uses the object. detection model, the joint position task estimation model, and the set parameters (determination criterions) to determine tasks by a worker in video data that is newly inputted from the camera 2.

Specifically, the task determination unit 107a, for example, inputs a frame image (still image) belonging to video data that is newly inputted from the camera 2 to an object detection model in the object detection unit 1071, and the dynamic body detection unit 1072. On the basis of the detected tool (object), the task table in FIG. 2, and the parameters, the task determination unit 107a determines the task by the worker, and obtains a value pertaining to the accuracy of the object detection. In addition, the task determination unit 107a estimates joint position information for the worker for each frame image (still image) in the same video data that was newly inputted, and inputs the estimated joint position information to a joint position task estimation model in the later-described joint position task estimating unit 1073. The task determination unit 107a obtains a result of estimating a task by a worker from the later-described joint position task estimating unit 1073, and a task classification probability that is estimated from joint positions.

The task determination unit 107a calculates the task classification probability from the obtained task classification probability estimated from the joint positions, the value pertaining to the accuracy of object detection, the set parameter, and the formula (1), and determines a task by the worker on the basis of the calculated classification probability and a detection result from the dynamic body detection unit 1072.

The joint position task estimating unit 1073 has a joint position task estimation model that is generated by the joint position task learning unit 109, inputs joint position information estimated by the task determination unit 107a to the joint position task estimation model, and outputs, to the task determination unit 107a, a result of estimating a task by a worker and a task classification probability that is estimated from joint positions.

### Parameter Calculation Processing by Task Analysis Device 1A

Next, description is given regarding operation pertaining to parameter calculation processing by the task analysis device 1A according to the second embodiment.

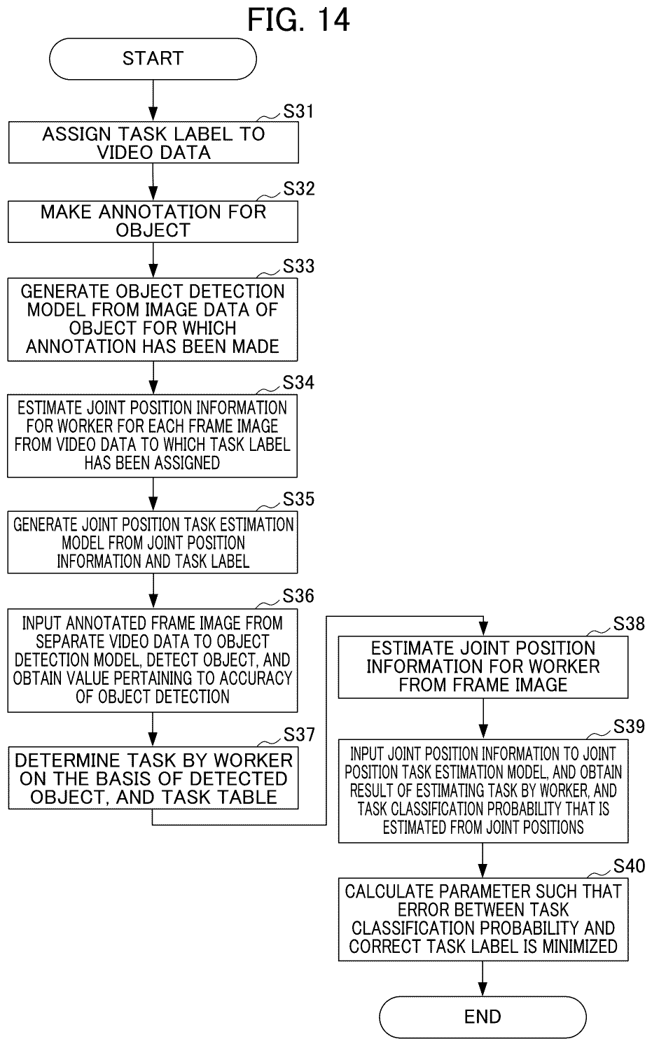

FIG. 14 is a flow chart for giving a description regarding parameter calculation processing by the task analysis device 1A. Note that processing in Step S31 through Step S33 is similar to processing in Step S1 through Step 83 in FIG. 9, and detailed description thereof is omitted.

In Step S34, the joint position estimating unit 108 estimates joint position information for a worker, for each frame image (still image) in video data that is stored in the input data storage unit 203 and to which a task label has been assigned.

In Step S35, the joint position task learning unit 109 performs machine learning that employs the joint position information estimated in Step S34 as input data and employs the task label assigned in Step S31 as label data, and generates a joint position task estimation model for estimating a task by a worker.

In Step S36, the task determination parameter calculation unit 105a inputs, to the object detection model, annotated frame image data from among separate video data, which is stored in the input data storage unit 203 and to which a task label has been assigned, detects a tool (object), and obtains a value pertaining to the accuracy of object detection.

In Step S37, the task determination parameter calculation unit 105a determines a task by the worker on the basis of the task table and a result of detecting an object in Step S36.

In Step S38, the task determination parameter calculation unit 105a estimates joint position information for the worker from frame images (still images) from the same separate video data.

In Step S39, the task determination parameter calculation unit 105a inputs the joint position information estimated in Step 538 to the joint position task estimation model, and obtains a result of estimating a task by the worker and classification probability that is estimated from the joint positions.

In Step S40, the task determination parameter calculation unit 105a calculates a value for a parameter (determination criterion) using Bayesian optimization or the like, such that the error between the task classification probability calculated by formula (1) and the correct task label is minimized.

### Analytical Processing by Task Analysis Device 1A

Next, description is given regarding operation pertaining to analytical processing by the task analysis device 1A according to the second embodiment.

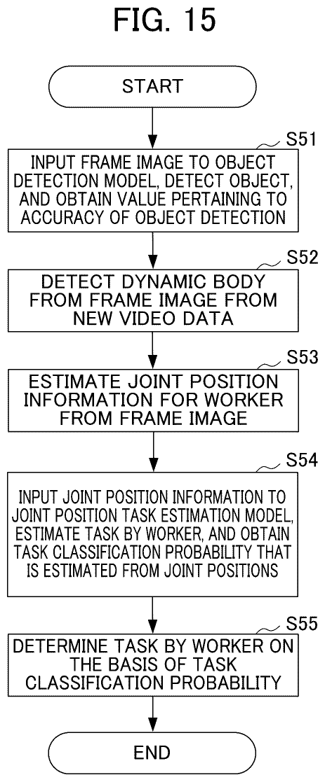

FIG. 15 is a flow chart for giving a description regarding analytical processing by the task analysis device 1A. The flow illustrated here is repeatedly executed while video data from the camera 2 is inputted.

In Step S51, the object detection unit 1071 inputs a frame image (still image), which is from video data that was newly inputted from the camera 2, to the object detection model, detects a tool (object), and obtains a value pertaining to the accuracy of object detection.

In Step S52, the dynamic body detection unit 1072 detects a dynamic body such as a worker or a tool on the basis of change such as change in luminance by a pixel in a designated image region from among each frame image (still image) in video data that is newly inputted from the camera 2.

In Step S53, the joint position task estimating unit 1073 estimates joint position information for the worker for each frame image (still image) in newly inputted video data.

In Step S54, the joint position task estimating unit 1073 inputs the joint position information estimated in Step S53 to the joint position task estimation model, and obtains a result of estimating a task by the worker and a task classification probability that is estimated from the joint positions.

In Step S55, the task determination unit 107a calculates the task classification probability from the task classification probability that was estimated from the joint positions and was obtained in Step S54, the value that pertains to the accuracy of object detection and was obtained in Step S51, the dynamic body detection result from Step S52, the set parameter, and the formula (1), and determines a task by the worker on the basis of the calculated classification probability.

As above, the task analysis device 1A according to the second embodiment can automatically adjust a determination criterion for causing a task to be accurately determined. In other words, if a user can label a task and make an annotation for an object, an optimal parameter is automatically calculated.

Description was given above regarding the second embodiment.

This concludes the description above regarding the first embodiment and the second embodiment, but the task analysis devices 1 and 1A are not limited to the embodiments described above, and include variations, improvements, etc. in a scope that enables the objective to be achieved.

### First Variation

One camera 2 is connected to each of the task analysis devices 1 and 1A in the first embodiment and the second embodiment, but there is not limitation to this. For example, two or more cameras 2 may be connected to each of the task analysis devices 1 and 1A.

### Second Variation

As another example, the task analysis devices 1 and 1A have all functionality in the embodiments described above, but. there is no limitation to this. For example, the some or all of the task registering unit 101, the task label assigning unit 102, the object detection annotation unit 103, the object detection learning unit 104, the task determination parameter calculation unit 105, the object detection annotation proposing unit 106, the task determination unit 107, the object detection unit 1071, and the dynamic body detection unit 1072 in the task analysis device 1 or some or all of the task registering unit 101, the task label assigning unit 102, the object detection annotation unit 103, the object detection learning unit 104, the task determination parameter calculation unit 105a, the joint position estimating unit 108, the joint position task learning unit 109, the task determination unit 107a, the object detection unit 1071, the dynamic body detection unit 1072, and the joint position task estimating unit 1073 in the task analysis device 1A may be provided by a server. In addition, each function by the task analysis devices 1 and 1A may be realized using a cloud-based virtual server function or the like.

Furthermore, the task analysis devices 1 and 1A may be a distributed processing system in which each function by the task analysis devices 1 and 1A is distributed among a plurality of servers, as appropriate.

### Third Variation

As another example, the task analysis device 1A does not have the object detection annotation proposing unit 106 in the embodiments described above, but may have the object detection annotation proposing unit 106.

As a result, in a case where task determination accuracy is insufficient, the task analysis device 1A can automatically propose a frame in a moving image that enables the task determination accuracy to be increased if an annotation is made.

Note that each function included in the task analysis devices 1 and 1A according to the first embodiment and the second embodiment can be realized by hardware, software, or a combination of these. Being realized by software means being realized by a computer reading and executing a program.

A program can be stored using various types of non-transitory computer-readable mediums and supplied to a computer. A non-transitory computer-readable medium includes various types of tangible storage mediums. An example of a non-transitory computer-readable medium includes a magnetic recording medium (for example, a floppy disk, magnetic tape, or a hard disk drive), a magneto-optical recording medium (for example, a magneto-optical disk), a CD-ROM (read-only memory), CD-R, CD-R/W, and a semiconductor memory (for example, a mask ROM, a programmable ROM (PROM), an erasable PROM (EPROM), a flash ROM, or a RAM). In addition, a program may be supplied to a computer by various types of transitory computer-readable mediums. An example of a transitory computer-readable medium includes an electrical signal, an optical signal, or electromagnetic waves. A transitory computer-readable medium can supply a program to a computer via a wired communication channel such as an electrical wire or an optical fiber, or via a wireless communication channel.

Note that steps that express a program recorded to a recording medium of course include processing in chronological order following the order of these steps, but also include processing that is executed in parallel or individually, with no necessity for processing to be performed in chronological order.

To rephrase the above, a task analysis device according to the present disclosure can have various embodiments which have configurations such as the following.

(1) The task analysis device 1 according to the present disclosure is a task analysis device that is for analyzing a task by a worker, and is provided with: the task label assigning unit 102 that assigns, to video data that includes the task by the worker, a task label that indicates the task by the worker; the object detection annotation unit 103 that, with respect to the video data to which the task label has been assigned, makes an annotation for an object related to the task by the worker; the object detection learning unit 104 that generates an object detection model for performing object detection, from video data regarding the object for which the annotation was made by the object detection annotation unit 103; the object detection unit 1071 that uses the object detection model to detect the object from the video data; the task determination parameter calculation unit 105 that performs a task determination on the video data to which the task label has been assigned, and calculates a determination criterion for minimizing an error with respect to the assigned task label; and the task determination unit 107 that uses the object detection model and the determination criterion to determine a task by the worker in newly inputted video data.

By virtue of this task analysis device 1, it is possible to automatically adjust a determination criterion in order to cause a task to be accurately determined.

(2) The task analysis device 1 according to (1) may include the object detection annotation proposing unit 106 that performs a task determination on the video data to which the task label has been assigned using the determination criterion calculated by the task determination parameter calculation unit 105 and, on the basis of a determination result from the task determination, propose a frame image for making an annotation.

As a result, in a case where task determination accuracy is insufficient, the task analysis device 1 can automatically propose a frame image in a moving image that enables the task determination accuracy to be increased if an annotation is made.

(3) The task analysis device 1A according to (1) or (2) may include: the joint position estimating unit 108 that estimates joint position information that pertains to joint positions for the worker; the joint position task learning unit 109 that, on the basis of the joint position information estimated by the joint position estimating unit 108 and information regarding the task label assigned by the task label assigning unit 102, generates a joint position task estimation model for estimating the task by the worker; and the joint position task estimating unit 1073 that, on the basis of the joint position task estimation model created by the joint position task learning unit 109, estimates a task from the joint position information, the task determination parameter calculation unit 105a, on the basis of a value pertaining to the accuracy of object detection in the task determination that used the object detection model, and a task classification probability that is estimated from joint positions in the task determination that used the joint position task estimation model, calculating the determination criterion such that an error with respect to the task label is minimized, and the task determination unit 107a determines a task by the worker in newly inputted video data using the object detection model, the joint position task estimation model, and the determination criterion.

As a result, the task analysis device 1A can achieve an effect that is similar to that for (1).

(4) The task analysis device 1 or 1A according to any of (1) to (3) may further include: the dynamic body detection unit 1072 that detects a dynamic body in the newly inputted video data, the task determination unit 107 or 107a determining whether the task by the worker is continuing on the basis of a time interval in which the dynamic body detection unit 1072 has detected the dynamic body.

As a result, the task analysis device 1 or 1A can determine a task by a worker with better accuracy.

(5) In the task analysis device 1 or 1A according to any of (1) to (4), the determination criterion may include at least a threshold for a value pertaining to accuracy of object detection, and an amount of time for which a task using a tool (object) can be estimated to continue from when the tool (object) is detected.

As a result, the task analysis device 1 or 1A can accurately determine a task by a worker even in a case where a tool (object) is not detected.

### EXPLANATION OF REFERENCE NUMERALS

1, 1A Task analysis device
2 Camera
10, 10a Control unit
101 Task registering unit
102 Task label assigning unit
103 Object detection annotation unit
104 Object detection learning unit
105, 105a Task determination parameter calculation unit
106 Object detection annotation proposing unit
107, 107a Task determination unit
1071 Object detection unit
1072 Dynamic body detection unit
1073 Joint position task estimating unit
108 Joint position estimating unit
109 Joint position task learning unit
20 Storage unit
201 Video data storage unit
202 Task registration storage unit
203 Input data storage unit

1. A task analysis device for analyzing a task by a worker, the task analysis device comprising:
a task label assigning unit configured to assign, to video data that includes the task by the worker, a task label that indicates the task by the worker;
an object detection annotation unit configured to, with respect to the video data to which the task label has been assigned, make an annotation for an object related to the task by the worker;
an object detection learning unit configured to generate an object detection model for performing object detection, from video data regarding the object for which the annotation was made by the object detection annotation unit;
an object detection unit configured to use the object detection model to detect the object from the video data;
a task determination parameter calculation unit configured to perform a task determination on the video data to which the task label has been assigned, and calculate a determination criterion for minimizing an error with respect to the assigned task label; and
a task determination unit configured to use the object detection model and the determination criterion to determine a task by the worker in newly inputted video data.

2. The task analysis device according to claim 1, comprising an object detection annotation proposing unit configured to perform a task determination on the video data to which the task label has been assigned using the determination criterion calculated by the task determination parameter calculation unit and, on the basis of a determination result from the task determination, propose a frame image for making an annotation.

3. The task analysis device according to claim 1, comprising:
a joint position estimating unit configured to estimate joint position information that pertains to joint positions for the worker;
a joint position task learning unit configured to, on the basis of the joint position information estimated by the joint position estimating unit and information regarding the task label assigned by the task label assigning unit, generate a joint position task estimation model for estimating the task by the worker; and
a joint position task estimating unit configured to, on the basis of the joint position task estimation model created by the joint position task learning unit, estimate a task from the joint position information, wherein on the basis of a value pertaining to accuracy of object detection in the task determination that used the object detection model, and a task classification probability that is estimated from joint positions in the task determination that used the joint position task estimation model, the task determination parameter calculation unit calculates the determination criterion such that an error with respect to the task label is minimized, and
the task determination unit determines a task by the worker in newly inputted video data using the object detection model, the joint position task estimation model, and the determination criterion.

4. The task analysis device according to claim 1, further comprising:
a dynamic body detection unit configured to detect a dynamic body in the newly inputted video data, wherein
the task determination unit determines whether the task by the worker is continuing on the basis of a time interval in which the dynamic body detection unit has detected the dynamic body.

5. The task analysis device according to claim 1, wherein
the determination criterion includes at least a threshold for a value pertaining to accuracy of object detection, and an amount of time for which a task using the object can be estimated to continue from when the object is detected.
